(19) United States
(12) Patent Application Publication
(10) Pub. No.: US 2015/0170304 A1
(43) Pub. Date: Jun. 18, 2015

(54) METHODS AND SYSTEMS FOR PROJECTING EARNINGS AND CREATING EARNINGS TOOLS WITHIN AN ONLINE CAREER NETWORK

(71) Applicant: Innovative Web, Inc., New York, NY (US)

(72) Inventor: Hunter DIAMOND, New York, NY (US)

(21) Appl. No.: 14/569,029

(22) Filed: Dec. 12, 2014

Related U.S. Application Data
(60) Provisional application No. 61/915,701, filed on Dec. 13, 2013.

(51) Int. Cl. G06Q 50/20; G06Q 10/04

(52) U.S. Cl. CPC G06Q 50/2057; G06Q 10/04

(57) ABSTRACT

Aspects of the present systems and methods provide ways for job seekers to determine projected earnings within an online career network. In some embodiments, the earnings may be projected based on various educational and career decisions that the candidate makes. Thus, a candidate is able to quantify how his or her educational and vocational decisions will affect projected earnings over his or her lifetime. Inputs for the present earnings projection system may be extracted from job seeker external profiles and/or databases (for example, social media or professional databases), or input manually by the candidate.

### CROSS REFERENCES TO RELATED APPLICATIONS

This application claims priority under 35 U.S.C. 119(e) to U.S. Provisional Application No. 61/915,701, filed Dec. 13, 2013, entitled, “Methods and Systems for Estimating Career Earnings,” the contents of which are incorporated herein in their entirety.

### TECHNICAL FIELD

The present disclosure relates to methods, systems, and computer program products for computing an individual's future earnings based on external and internal data inputs and creating an earnings tool within an online career network.

### BACKGROUND

Many students and young professionals wonder how their educational and career decisions may affect their earnings potential each year and over their careers. Unfortunately, there is currently no quantitative way to measure, at an individual level, how specific educational and vocational choices ultimately may drive a job seeker's earnings. Currently there are various web and print sources to find average earnings for certain jobs, but there is currently not an automated way to determine a personalized metric of how skills, degrees, and work experience as whole contribute to a job seeker's projected earnings each year and over their lifetime. Additionally, customized compensation reports such as those provided by Payscale, allow a user to view a personalized current salary projection and provide average salaries for related careers that the user may end up pursuing, yet these reports do not provide an individual projection of what a user is likely to earn over their lifetime and how the individual can alter their earnings trajectory with various decisions. Traditional methods, at most, estimate what a market rate salary is but do not account for how an individual's salary is likely to change as a result of other variables, for instance demographic trends and salary increases. Likewise, with students and young professionals increasingly searching for information relating to future career paths, new techniques are needed to utilize earnings projections within an online career network to increase user engagement and provide further earnings related tools to job seekers within widely used online career networks.

### SUMMARY

The present disclosure describes systems and methods for users to determine projected earnings within an online career network. In some embodiments, the methods for determining projected earnings may include determining relevant individual metrics for a user. The methods may further include, for each relevant individual metric: determining a weighted metric based at least in part on the individual metric, determining a weighted contribution factor based at least in part on the weighted metric and on a contribution factor, and determining an earnings contribution for the weighted metric based at least in part on the contribution factor. The methods may also include determining projected earnings results based at least in part on the earnings contribution. The system also allows users of an online career network to alter system inputs in order to see how they can improve their earnings. Additionally, the earnings projection system can be integrated within other parts of an online career network to increase user engagement and career progression.

The present disclosure also describes systems and computerized methods of encouraging user engagement in an online career network by leveraging employment-related information corresponding to the users in the online career network. In some embodiments, the systems and methods include receiving, by a computing device, profile information corresponding to a user and a request for an earnings projection corresponding to the user, the profile information comprising at least one category of information related to at least one of skills, employment or education. In some embodiments, the systems and methods include extracting, by the computing device, a data profile subset based on the request, the data profile subset including a set of the at least one category from the user profile information. In some embodiments, the systems and methods include assigning, by the computing device, a score to the user profile information, wherein assigning the score comprises at least one of: comparing, by the computing device, the data profile subset with user profile data from a database of user profiles, the database user profiles including at least one category in common with the at least one category from the user profile information; and calculating, by the computing device, the score by at least one weight to the at least one category. In some embodiments, the systems and methods include outputting, by the computing device, a user output based on the score, the user output comprising: projected earnings corresponding to the user in relation to a set of profiles from the database of user profiles, and a link to an earning tool, the earning tool comprising an activity related to increasing projected earnings of the user.

### BRIEF DESCRIPTION OF DRAWINGS

Various embodiments of the present systems and methods are disclosed in the following description and accompanying drawings, in which like elements are referenced with like numerals. These drawings should not be construed as limiting the present disclosure, but are intended to be exemplary only.

FIG. 1A illustrates an example earning projection system, in accordance with certain embodiments.

FIG. 1B illustrates an example block diagram showing various elements of a career guidance system, in accordance with certain embodiments.

FIG. 1C illustrates an example block diagram representing individual components of a recommendation engine, in accordance with certain embodiments.

FIG. 1D illustrates an example data input interface to the present earnings projection system, in accordance with certain embodiments.

FIG. 2 illustrates an example database used within the present earnings projection system, in accordance with certain embodiments.

FIGS. 3A-3D illustrate example output interfaces to the present earnings projection system, in accordance with certain embodiments.

FIG. 4A illustrates an example database in the present earnings projection system in accordance with certain embodiments.

FIG. 4B illustrates example databases to assign relevant earnings projection coefficients within the present earnings projection system, in accordance with certain embodiments.

FIG. 5 illustrates an example flowchart of a process performed by a user within earnings projection system 106, in accordance with certain embodiments.

FIG. 6A illustrates an example flowchart of a process for retrieving user data and performing the earnings projection calculation, in accordance with certain embodiments.

FIG. 6B illustrates an example flowchart for a process for determining an earnings projection, in accordance with certain embodiments.

FIG. 7 illustrates example internal and external data sources in earnings projection system output, in accordance with certain embodiments.

FIG. 8 illustrates an example recruiter interface for earnings projection output, in accordance with certain embodiments.

FIG. 9 illustrates an example advertisement within earnings projection system 106, in accordance with certain embodiments.

FIG. 10 illustrates an example earnings projection systems calculation, in accordance with certain embodiments.

FIG. 11 illustrates an example flowchart of a process in which Knowledge Discovery in Databases (KDD) is used within the present earnings projection system, in accordance with certain embodiments.

FIG. 12 illustrates a user interface for an earnings projection system within an online career network, in accordance with certain embodiments.

### DESCRIPTION

The present disclosure describes methods and systems for estimating and projecting a job applicant's current and future earnings. Job seekers benefit from direction in terms of what actions they can take to maximize their current and future earnings. The present earnings projection systems can be used to see what actions will contribute most to a job seeker's earning potential. Job seekers also do not currently have a way to see how educational and career decisions their friends and colleagues make have affected their lifetime earnings, and evaluate themselves accordingly. The present systems and methods provide useful tools, as they provide job seekers with ways to figure out how to achieve their career earnings goals.

The present disclosure also describes methods and systems for ranking a job applicant's future earning potential against other job applicants. As young professionals are curious as to where they stand in the job application realm versus other applicants, an earnings projection system can be reconfigured to rank users numerically with each other in order to discern the most qualified candidates, as earnings are many time used to cull the top applicants. This ranking is useful to job seekers as it motivates them to improve their career prospects relative to their peers and it is equally useful to recruiters in finding top applicants.

In certain embodiments, an earnings projection system can be used to estimate a user's current and expected lifetime earnings. For purposes of the present disclosure, a “user profile” refers to the individual user's data which serves as an input to the present earnings projections system. An “earnings database” refers to the database used to store inputted, pulled, and extracted data used to compute earnings projections. “Comparable profiles” refer to profiles used to extract further insights for a ranking database. Comparable profiles may be distinguished from user profiles. Comparable profiles generally provide a way to compare a user profile among friends and colleagues. Comparable profiles may be input by a candidate, extracted from external data, or selected by a computer system and/or algorithm. In further embodiments, the requesting user may filter or further refine the comparable profiles to provide a more specific ranking in a subset of his or her existing network. A “representative user profile” refers to a mean, average, or a representative profile of a group or organization that may be input into the earnings projection system to obtain significant earnings drivers for a specific group. In some embodiments, the representative user profile may be based on aggregate user profile information of all users within a group or organization.

Within a business or social networking service consistent with embodiments of the present systems and methods, a job recruiter may use data from the present earnings projection systems to view top candidates in select industries and/or specialties. For example, a job recruiter may filter and/or sort candidates based on data from the ranking database. In some embodiments, the user interface by which a job recruiter searches, sorts, and contacts candidates may be dramatically different than the user interface used by job seekers. The rankings presented may also not be in an earnings format, but may be numerical (for example, 1-100) or otherwise formatted in another type of hierarchical scale. The output for a particular user within the present earnings projection system may also not be hierarchical, but may be a graphical or other visual interface. For example, a user may see a picture of differently sized dollar sign “$” bags representative of the value of the user's lifetime earnings relative to his or her friends and/or acquaintances. Larger bags may represent greater lifetime earnings and smaller bags may represent lesser earnings power with respect to the user's social network.

The user may initiate the present earnings projection system, but in other cases, an application or process may initiate the present earnings projection system. For instance, a career recommendation application used by a university career center may initialize the present earnings projection system with a representative user profile, to find areas that are significantly lowering mean salaries of their graduating classes, effectively finding factors that can most significantly increase average earnings of their graduating classes.

In some embodiments, an advertising system can be implemented within the present earnings projection system. The advertising system is described in further detail below. For example, a relevant advertisement can be presented to a user based on results from the present earnings projection system. Advertisements can be presented to the individual user, as well as to friends and/or colleagues according to the user's comparable profiles, and many users. For example, a relevant advertisement to take a programming course could be presented to a user and other users in his or her network, based on output computed from the present earnings projection system.

In some embodiments, the present earnings projection system may function in two phases: (1) extracting relevant data and (2) projecting a user's earnings. In the first phase, a data extraction engine processes relevant data points from a user profile, to extract relevant data on which earnings projections will be performed. For example, in a user profile, only certain relevant data points may be extracted for performing the earnings projection computation. In addition to extracting relevant data points from the user profile, the present system derives certain features based on other information in the earnings projection input or otherwise available to the present earnings projection system (for example, based on the user profile). Using the example of a user profile, an example data point may be years of work experience. Although this data point for years of work experience might not exist in raw form in a user's profile, years of work experience can be derived by a calculation based on the member's date of graduation to the present. At times user profile data may use different language and/or formats, as a result the earnings projection system may attempt to reconcile the differences of user input into a standardized format. Various other data points may be retrieved by from external data sources, utilizing information in the earnings projection system as part of a query to the external data source.

The first phase of the present system may run in real time or offline. Due to the amount of data being processed, the process may also occur on a distributed computing platform. The augmented user profile created by the data extraction engine is used in the second phase of the present earnings projection system, i.e. using the relevant profile data to project a user's earnings. For example, the present earnings projection system may use a configuration file tailored to perform the required computation and may input or extract data from the ranking database. By way of example, a second configuration file could be used to provide relevant career suggestions for a user, using the earnings projection system, but using a different algorithm for computing relevant careers based on the ranking database, comparable profiles, and/or other external sources. Further ramifications of the present systems and methods will become evident from the Figures included in this document.

In the following description, for purposes of explanation numerous specific details are set forth in order to provide a thorough understanding of the various aspects of different embodiments. It will be evident, however, to one skilled in the art, that the present systems and methods may be practiced without all of the specific details.

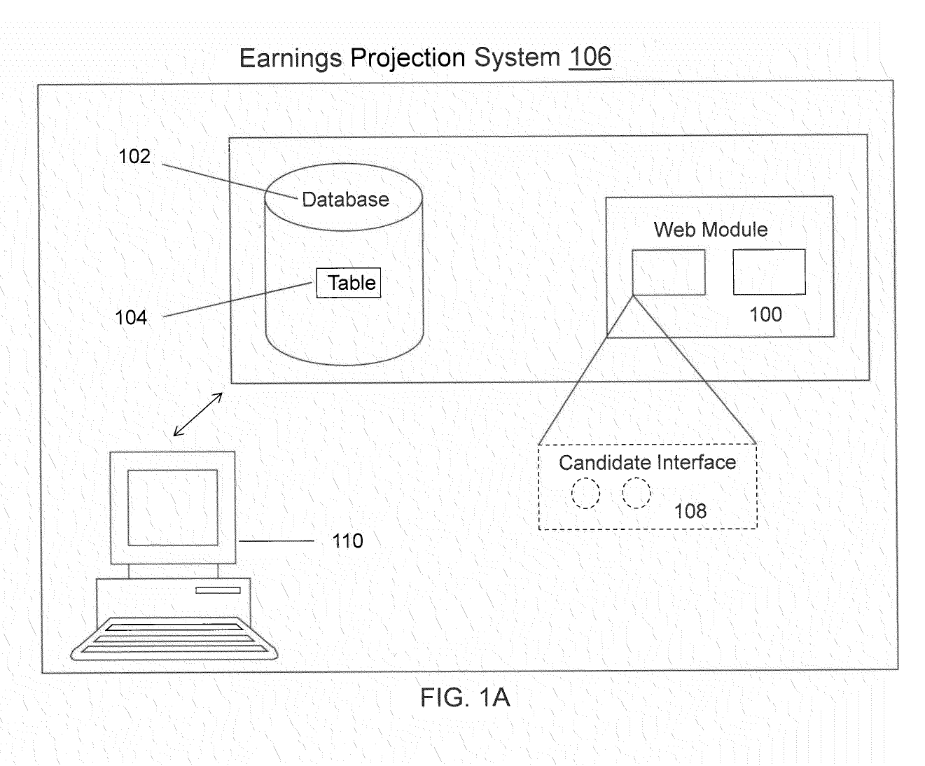

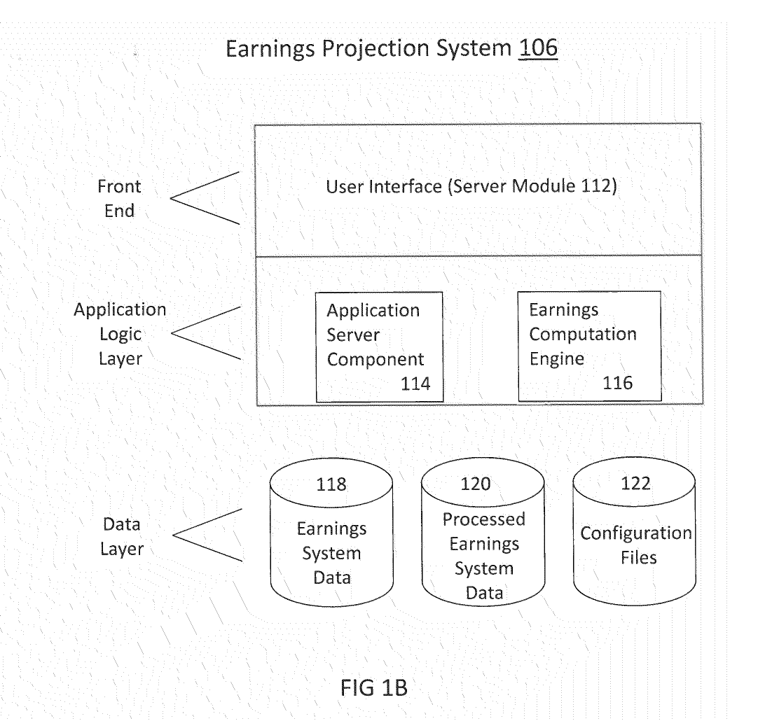

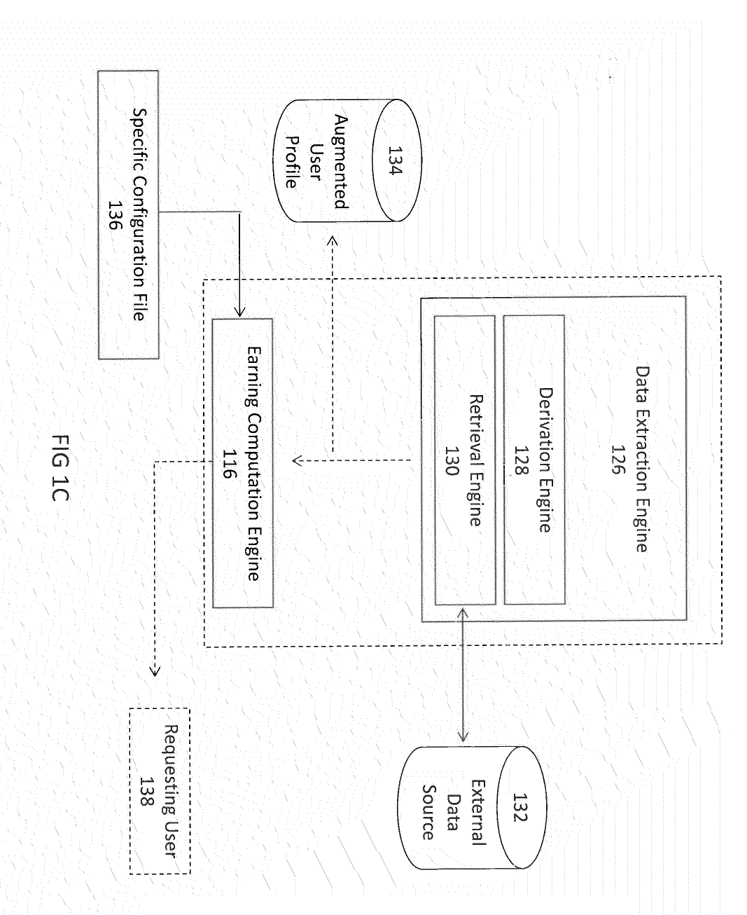

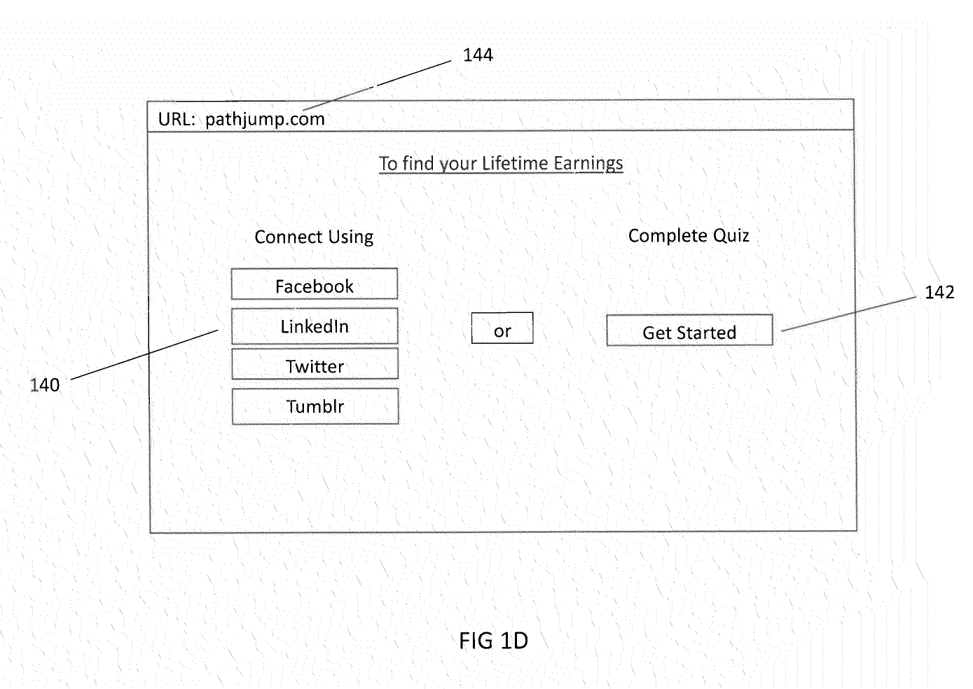

FIG. 1A illustrates an example earnings projection system 106, in accordance with certain embodiments. Specifically, FIG. 1A illustrates an example environment of an earnings projection system 106 with a database 102 for storing comparable profiles and ranking database, in accordance with certain embodiments. Earnings projections system 106 includes a web module 100 that functions as a web server to deliver web pages to the user. Database 102 and tables 104 consist of stored comparable user profiles, configuration files, and a ranking database. Candidate interface 108 presents output of earnings projection system 106 to the user. Candidate interface 108 may be altered by the configuration files as needed, based on the required output. In some embodiments, device 110 is the user's desktop or mobile device. Device 110 receives, transmits, and displays data from the present earnings projection system. Depending on the amount of users and data being processed within the present earnings projection system, the process may occur on multiple servers rather than on a single platform.

When an earnings projection occurs, the data is input into database 102 and tables 104; this allows a comprehensive database to be created. As explained in further detail below, data stored within database 102 and tables 104 is used in other processes within the present earnings projection system. The processing of data between database 102, tables 104, and web module 100 is dynamic and can occur in bulk or distributed increments.

FIG. 1B illustrates an example block diagram showing various elements of a career guidance system, in accordance with certain embodiments. User interface 112 is the front-end of the present system and is used by the user to communicate with the rest of the system. The user interface may transmit information by various methods, including Hypertext Transport Protocol (HTTP), File Transfer Protocol (FTP) but other methods may be used. The user interface also receives information from the application server component 114 and earnings computation engine 116, as well as from the data layer. In some instances, the application server component is used in conjunction with the earnings projection system to perform various services. By example, the application server component 114 is utilized in conjunction with the earnings computation engine to output earnings projections for a user profile.

FIG. 1B also illustrates numerous databases. Specifically, earning system data 118 consists of earnings system data used for storing internal and external coefficients and weightings of various factors affecting user's earnings. In some embodiments, each module, component and engine represents executable software interacting with hardware components. In other embodiments, the present systems and methods may be implemented entirely as hardware components, or entirely as executable software. More extensive modules, components, and engines could be incorporated. To achieve a more simplified description, the more extensive aspects are omitted. Some examples of items which may be stored in earnings system data 118 include ranking database items such as: external educational rankings, external employer rankings, and report's concerning individual skill's contribution to earnings. Earnings system data 118 are ultimately refined and standardized for inclusion in processed earnings system data 120. Earnings system data 118 may be stored statically or may be dynamically linked to external sources. For instance, earning system data 118 may update dynamically as updated university rankings are released, for example by U.S. News and World Report. In some embodiments, the present system processes earnings system data 118 in the background, to allow the present earnings projection system to access processed ranking data and conduct other operations in real time. Configuration files database 122 includes various application configuration files, including a configuration profile to project an individual's lifetime earnings. These configuration files are used selectively with the present earnings projection system 106, depending on the specific computation needed. For instance, a group comparison configuration file can be used with earnings computation engine 116, to compute earnings of comparable profiles relative to the requesting user's profile. In other embodiments, an individual earnings file can be utilized with earnings computation engine 116, to compute the individual's future earnings.

FIG. 1C illustrates an example block diagram representing individual components of a recommendation engine, in accordance with certain embodiments. FIG. 1C illustrates an example order of events within the present earnings projection system, beginning with input of user profile data into data extraction engine 126. In some embodiments, the present earnings projection system includes two components, data extraction engine 126 and earnings computation engine 116.

In some embodiments, data extraction engine 126 includes derivation engine 128 and retrieval engine 130. Derivation engine 128 functions to extract various features from the user profile. Earnings computation engine 116 can be customized by a specific configuration file 136 to perform a specific type of earnings projection computation based on the user's request. For example, the user's request may not be limited to projecting earnings but also may include determining earnings projection trends within a group of users. That is, a university career center may be interested in finding out what is most responsible for driving its graduates' mean earnings and therefore input thousands of user profiles into earnings projection system, to receive as output a comprehensive detailing of statistics and data regarding their graduating classes' earnings. Derivation engine 126 processes the raw user profile data and converts raw data into processed earnings system data. Derivation engine 126 standardizes and normalizes user profile data, facilitating meaningful comparisons among all profiles. For example, listed skills such as “editing” may have different meanings within different industries: for example, film editing, copyright editing, or editing financial models. Normalizing and standardized such input allows more accurate earnings computations. There may also be elements that can be derived from the raw user profile data, although not explicit, which are derived by the derivation engine. For example, total years of work experience can be calculated by summing all the years of employment. Retrieval engine 130 may use input queried into data extraction engine 126 to obtain data from external data source 132. The data obtained from retrieval engine 130 can then function as additional input into earnings computation engine 116 and can also be attached and stored with the respective augmented user profile.

Earnings computation engine 116 is used in conjunction with specific configuration file 136 in order to compute requested earnings output. Specific configuration file 136 describes what elements from the augmented user profile will be used to provide earnings projection output. Specific configuration profile 136 specifies exact weightings and data points to be used in computation, and allows for creation of varied earnings projection output. For example, a specific configuration file can be used with the earnings computation engine for predicting the earnings of engineering professionals, which might carry different variables and/or weightings than the configuration file used for medical professionals.

FIG. 1D illustrates an example data input interface to earnings projection system 106, in accordance with certain embodiments. Browser URL 144 accesses a website. The website presents ways for the job seeker to input his or her relevant information. Data may be imported from existing social media profiles 140 or may be entered manually by completing a comprehensive assessment (“Quiz”). For example, the user may press Get Started button 142 to begin the quiz. User data may also be imported from external sources, uploaded, or extracted by numerous other techniques.

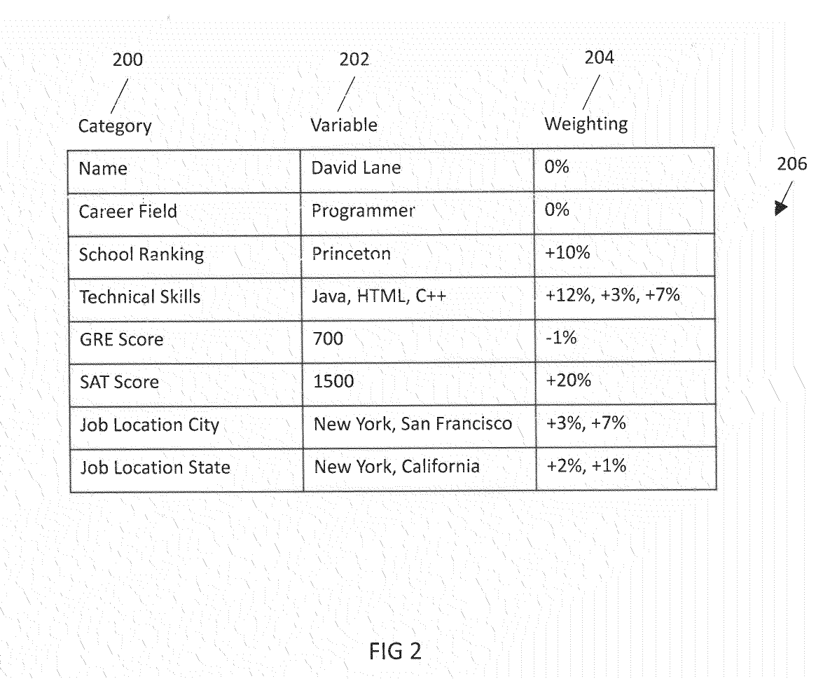

FIG. 2 illustrates an example database 206 used within the present earnings projection system, in accordance with certain embodiments. Although FIG. 2 illustrates a simplified rankings database 206, more complicated databases may be used as well. In some embodiments, database 206 may be stored in a relational database management system (RDBMS) such as MySQL. Each category 200 may be stored with a variable 202 and a weighting 204 specific to variable 202. Some categories and/or variables may not contain a weighting, for example a user's name. Categories can contain single or multiple variables. For example, in FIG. 2 the technical skills category contains Java, HTML, C++, with each technical skill being associated with a unique weighting. The weightings associated with each variable can be static or dynamic (for example, linking internal or external sources). Each database 206 can be associated with one or multiple configuration files. Configuration files work in tandem with databases 206 in order to compute earnings output based on input user data. In other embodiments, database 206 in the present earnings projection system can be implemented in numerous other ways.

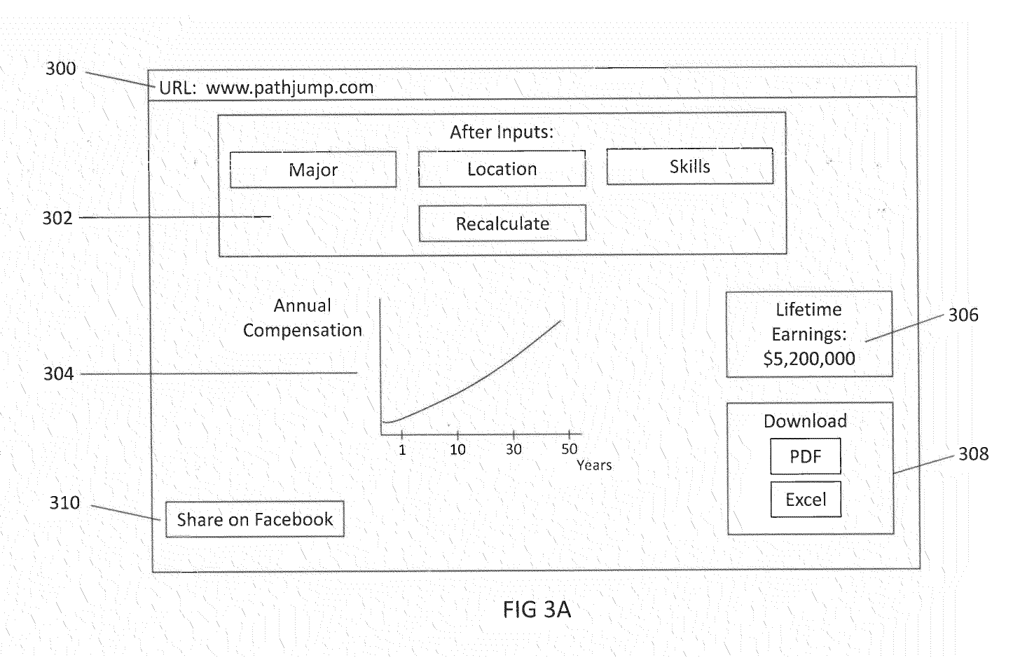

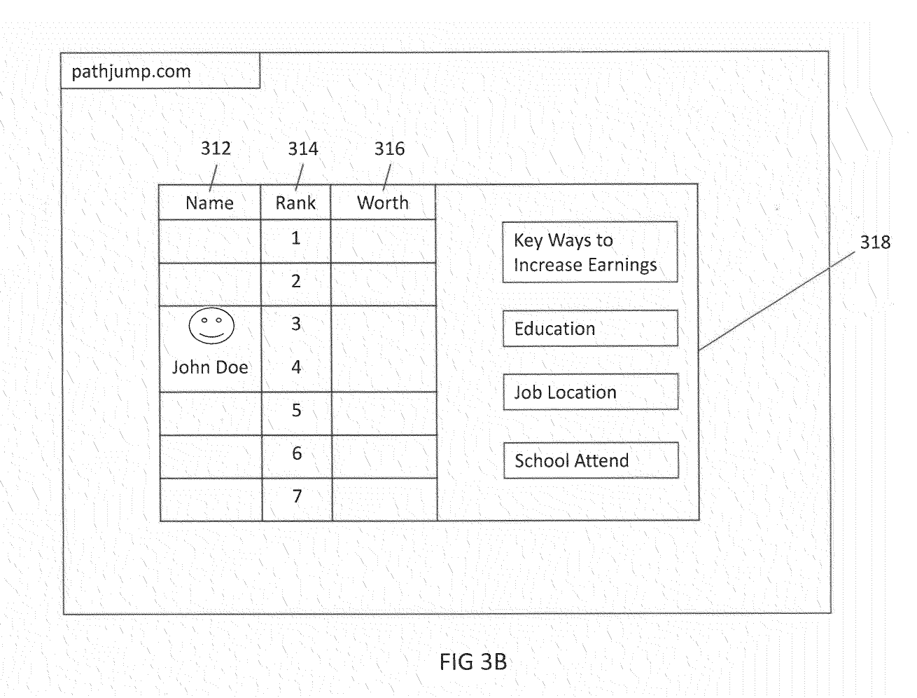

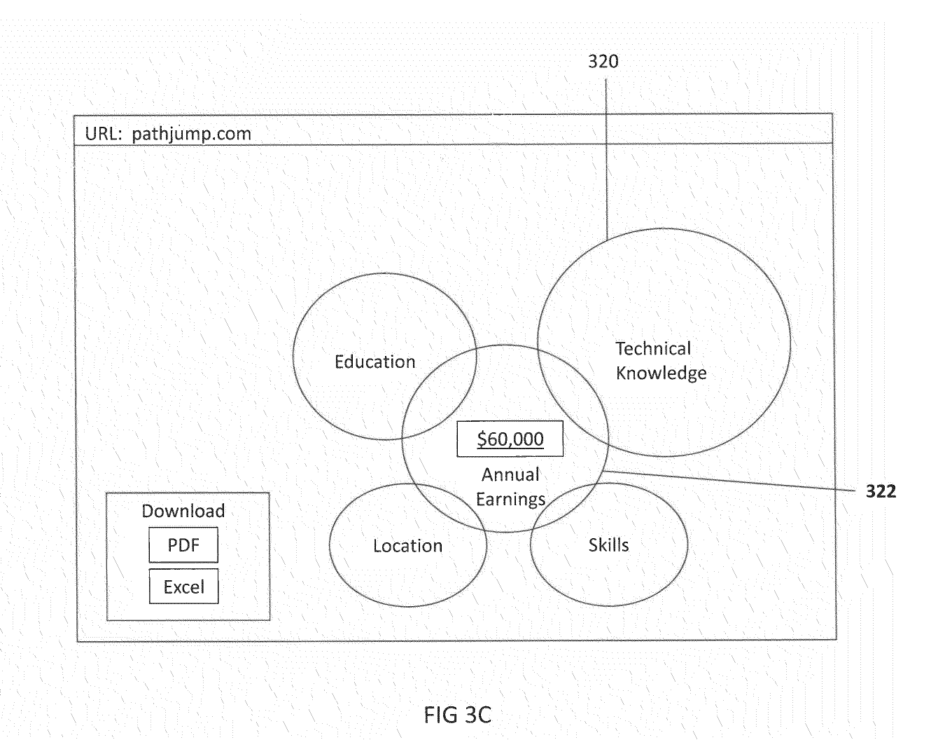

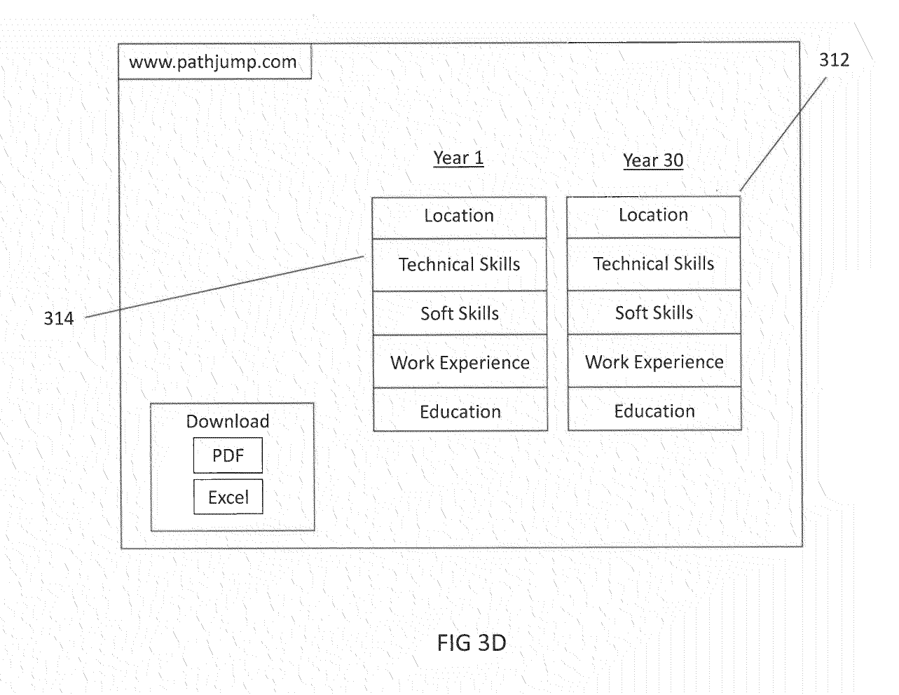

FIG. 3A illustrates example user output in earnings projection system 106, in accordance with certain embodiments. In some embodiments, a user uses a browser to access URL 300 of earnings projection system 106. Once relevant user data has been extracted, earnings projection output 306 is displayed to the user. In further embodiments, multiple outputs can be provided. For example, FIG. 3A illustrates an annual compensation graph depicting future annual earnings 304. FIG. 3A shows example output as expected lifetime earnings, but the output may be modified based on configuration files. Inputs 302 may also be altered, to provide revised output. Once inputs 302 have been modified the user can recalculate his or her earnings projection output. This recalculation allows a user to experiment or otherwise determine data points most pertinent to his or her earnings projection output. In further embodiments, the user also has the ability to share his or her results on social networks 310 or export 308 the results.

FIG. 3B illustrates another example of user output in the present earnings projection system, in accordance with certain embodiments. FIG. 3B illustrates that the user is able to view his or her existing social network 312 ranked individually 314, sorted by net worth projections output by the present earnings projection system. This allows an individual to compare his or her own earnings potential to the earnings potential of his or her friends and acquaintances, and figure out how to improve his or her projected earnings. Users are presented with various variables 318 which when changed would result in the user moving up relative to his or her network and/or the set or subset of comparable profiles.

FIG. 3C illustrates an example graphical user output 320 in earnings projection system 106. The user interface incorporates projected annual earnings 322 of the user. Thus, example earnings projection output is not required to be numerical output, but instead can be graphical, illustrative, or use any other format effective for visualizing projected earnings.

FIG. 3D illustrates another example of user output in accordance with certain embodiments. The present systems allow users to view projected factors at certain stages of their life. For example, the user may view how factors 314 at year 1 may affect current or projected earnings potential. Example factors may include location, technical skills, soft skills, work experience, or education. The user may also view how factors 312 at year 30 may affect current or projected earnings.

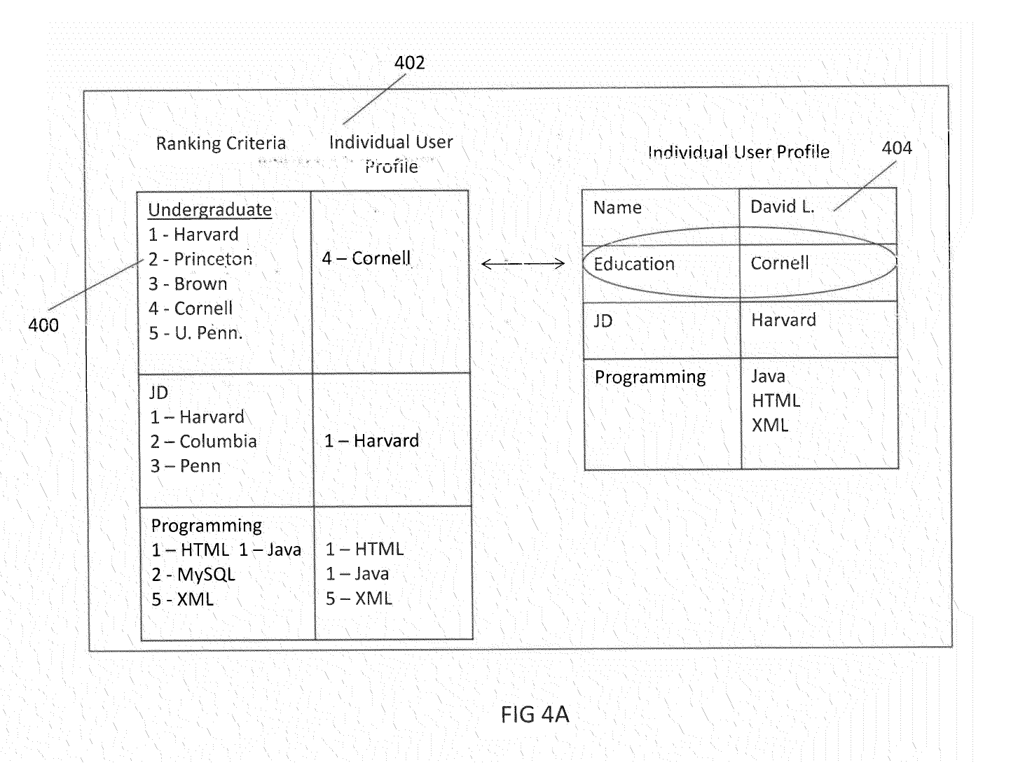

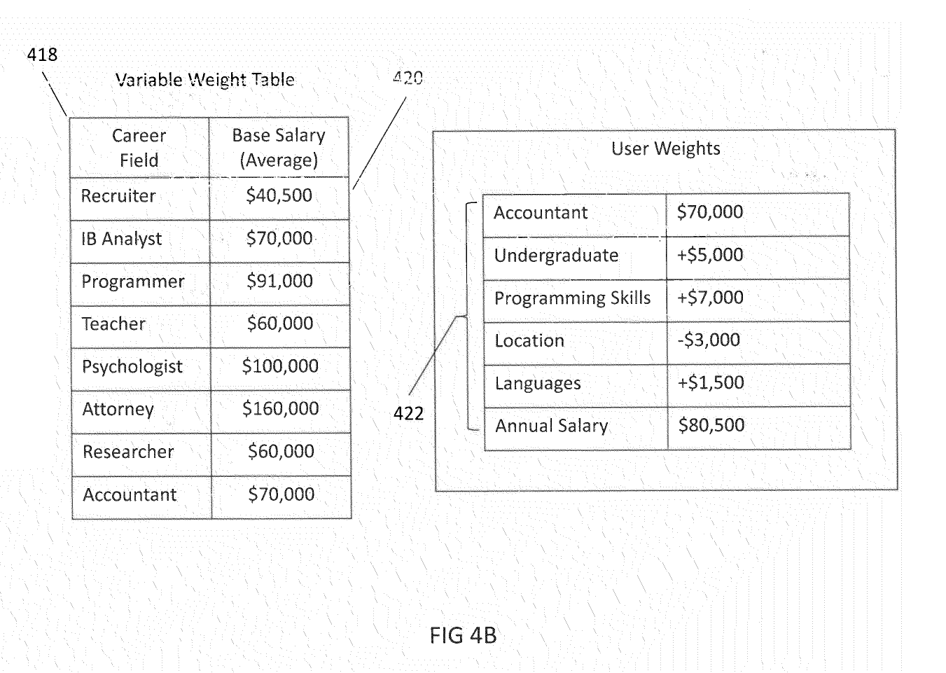

FIG. 4A illustrates an example database in earnings projection system 106 in accordance with certain embodiments. Ranking system 400 compares individual user profile 402 to relevant metrics to determine earnings projection output. The present system then assigns scores to metrics based on how the metric compares to the ranking system data used by the configuration file in the present earnings projection system.

FIG. 4B illustrates example databases to assign relevant earnings projection coefficients within earnings projection system 106, in accordance with certain embodiments. In FIG. 4B, each career field 418 is assigned a salary reflective of what the average professional is likely to earn within the field. These salaries are stored in a variable weight table. The metric computed for the user based on the variables is then stored in the user's profile 422, with the variables assigned specific metrics which are than weighted based on the variable's expected importance to a user's earnings.

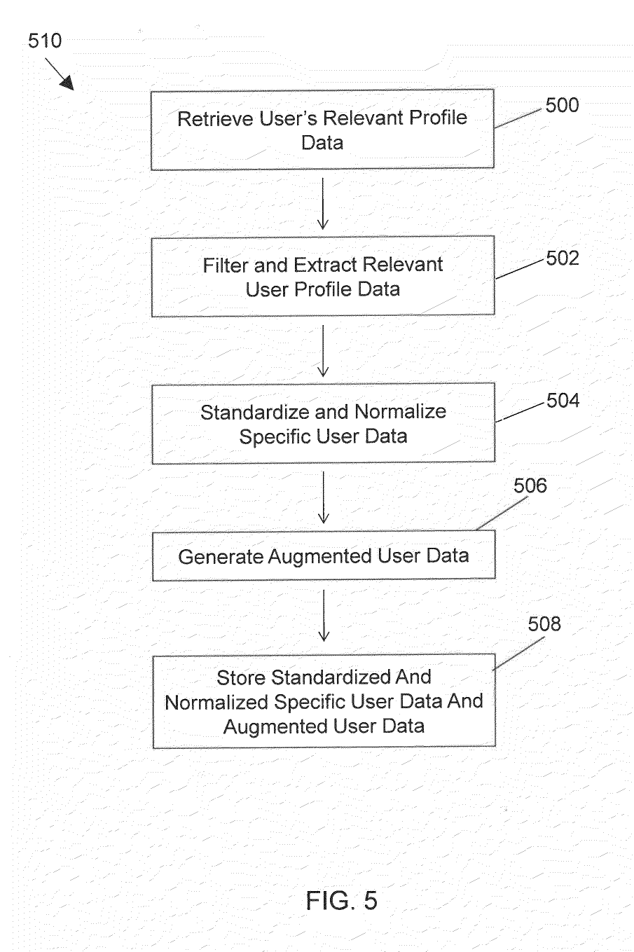

FIG. 5 illustrates an example flowchart of process 510 performed by a user within earnings projection system 106, in accordance with certain embodiments. Specifically, FIG. 5 illustrates an example of method operations involved in a method of retrieving, extracting, standardizing, expanding, and storing user profile data for use by the present earnings projection system, according to some embodiments. In some embodiments, some method operations illustrated in FIG. 5 may be performed offline using process performed on a consistent timetable (for example, hourly, daily, weekly, monthly, yearly), or the operations may be performed online in real time. First, the user's raw relevant profile data is retrieved from either an internal or external database, or entered manually (step 500). The relevant user profile data is filtered and extracted to become processed earnings system data (step 502). The processed earnings system data is standardized and normalized to allow accurate earnings projection computations (step 504). The data is then augmented (step 506). In some embodiments, the present system augments the data by deriving certain data elements and/or importing expanded data from external data sources. For example, an external data source containing information on a user's skills may be queried and used to fill in more detail. The present system then stores the standardized and augmented user data is stored in respective databases (step 508).

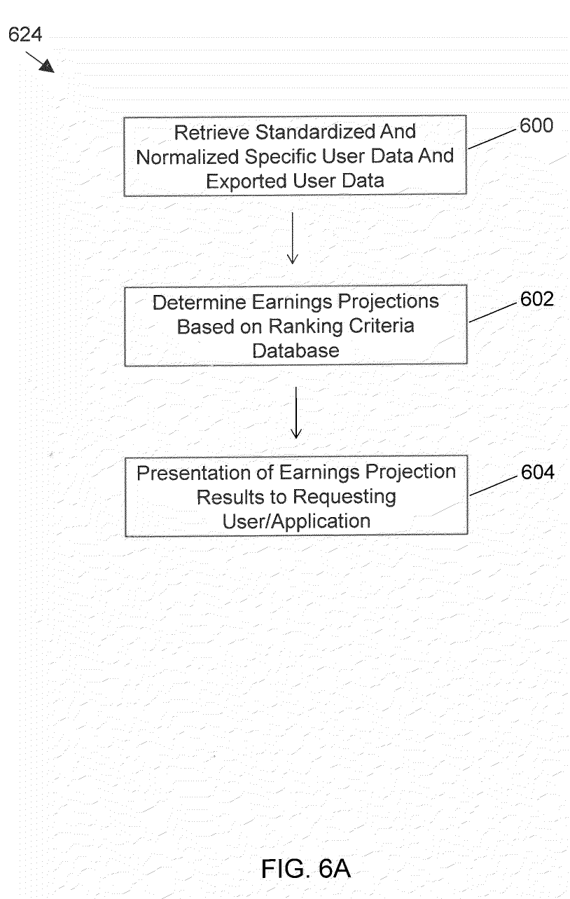

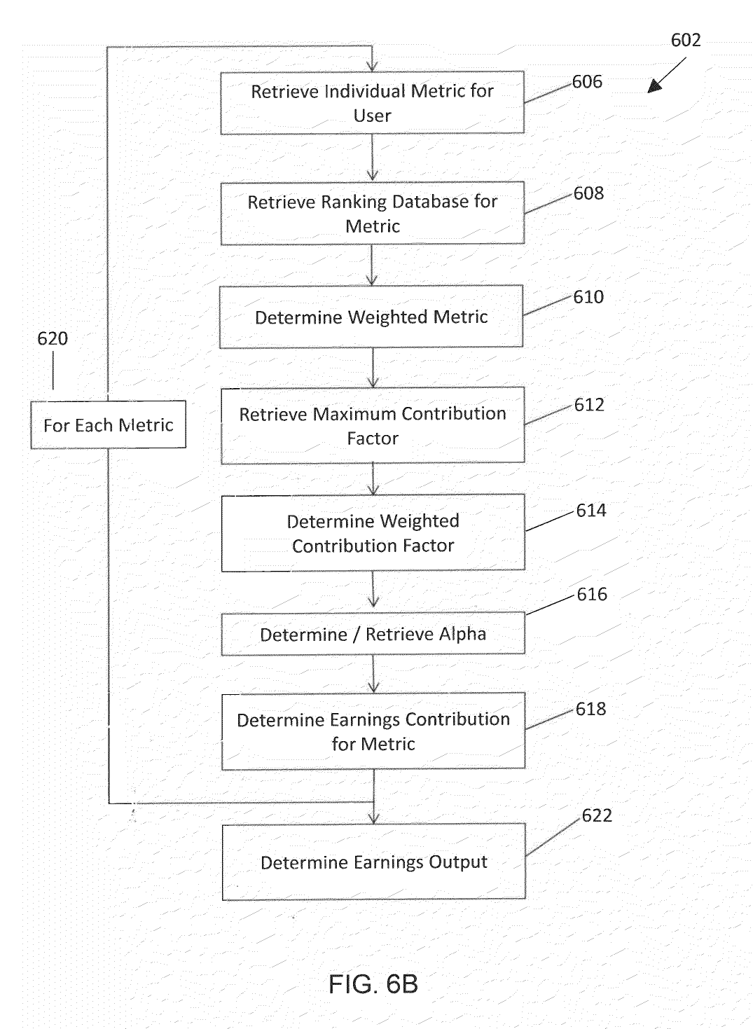

FIG. 6A illustrates an example flowchart of process 624 for retrieving user data and performing the earnings projection calculation, in accordance with certain embodiments. Specifically, FIG. 6A illustrates an example of method operations involved in a method of retrieving, calculating and presenting earnings projection output to the user in an earnings projection system, according to some embodiments. The present system retrieves standardized and augmented user data (step 600). In some embodiments, retrieval can occur by a user or application querying the processed earnings system database. The ranking database is queried to select necessary data to run with a configuration file to determine earnings projection based on ranking criteria database (step 602). Step 602 is described in further detail below, in accordance with FIG. 6B. The present system presents earnings projection output to the requesting user/application (step 604).

FIG. 6B illustrates an example flowchart for process 602 for determining an earnings projection, in accordance with certain embodiments. The present system retrieves a relevant user metric (step 606). In some embodiments, as described earlier the metric may be internally or externally stored, and may be dynamic or static. For example, if the relevant metric is “university attended,” “Cornell University” might be the user's metric that is retrieved. The present system retrieves a ranking database associated with the metric (step 608) to compute the relevant score for the user. For example, following the previous example a ranking hierarchy of top universities would be retrieved. The present system compares the retrieved metric for the user to the ranking database for the metric, to compute a weighted metric (step 610). In some embodiments, in the previous example, Cornell University could be ranked by percentile based on its order on the list. The weighted metric is determined relative to the retrieved maximum contribution factor (step 612). Referencing the previous example, a maximum earnings contribution of $70,000 per year might be assigned to the top university within the rankings database. The earnings projection calculation would then compare the user's metric ranking to the maximum earnings contribution for the factor, to compute a weighted contribution factor (step 614). In addition to the computed factors, an additional coefficient, also referred to as “alpha,” may be used to adjust the weighted metric (step 616). Alpha functions to make the earnings projection calculation more precise. For example, if a group of users all in a certain club have earned statistically more per year, and a specific user is a member of that club, an alpha coefficient may be implemented to better project the earnings for the specific user. In some embodiments, alpha may be calculated dynamically, based on where the user's metric is, relative to the metric's ranking database. By way of the previous example, alpha may be an addition of $10,000 in the earnings computation when the user's metric is in the 1-20 ranking of universities, and an additional $5,000 if the user's university metric is greater than 21. The present system uses alpha to adjust the weighted metric mathematically. After alpha is computed or retrieved, the metric's earning contribution is computed (step 618). In some embodiments, the metric's earnings contribution may be computed by determining a summation of the weighted contribution factors and alpha. Numerous other computations involving the weighted contribution factor and alpha may also be used. The previously described steps are performed iteratively for relevant metrics of the user profile (step 620). Once all the user's metrics earnings contributions are calculated, the present system uses the contributions to calculate an earnings output (step 622). In some embodiments, the present system calculates the earnings output by determining the summation of each metric's earnings contribution. In other embodiments, numerous more intricate manipulations of each metric's earnings computation could be performed to calculate earnings output.

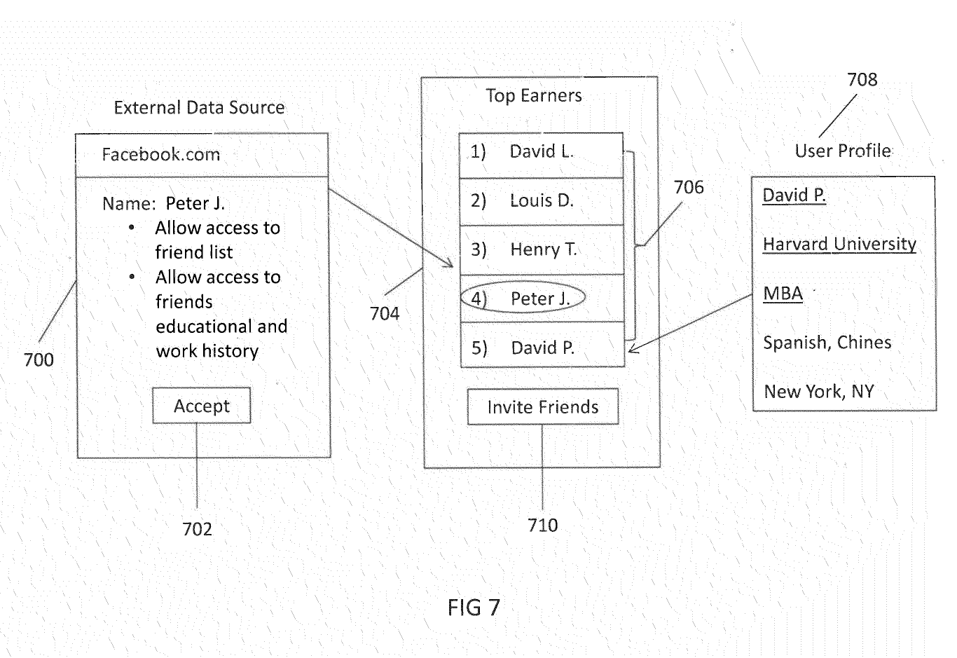

FIG. 7 illustrates example internal and external data sources in earnings projection system output, in accordance with certain embodiments. Specifically, FIG. 7 illustrates input sources and output interfaces in a ranking system within an earnings projection system. In some embodiments, an external data source could be a social network application programming interface (API) 700, which a user or application would provide access via the present earnings projection system to the user's profile information using a form control 702. For example, FIG. 7 illustrates that Peter J's profile 704 is used to create an earnings projection output including profiles created by internal and external data sources. In some embodiments, internal data sources could include a user's completed career assessment 708, which would then be utilized to provide earnings projection output. For example, David P's profile information is then used to provide output, which includes top earnings of a subset of user profiles and comparable profiles 706. Further users can also be added to the output dynamically, for example by giving a user the ability to invite others within his or her network 710.

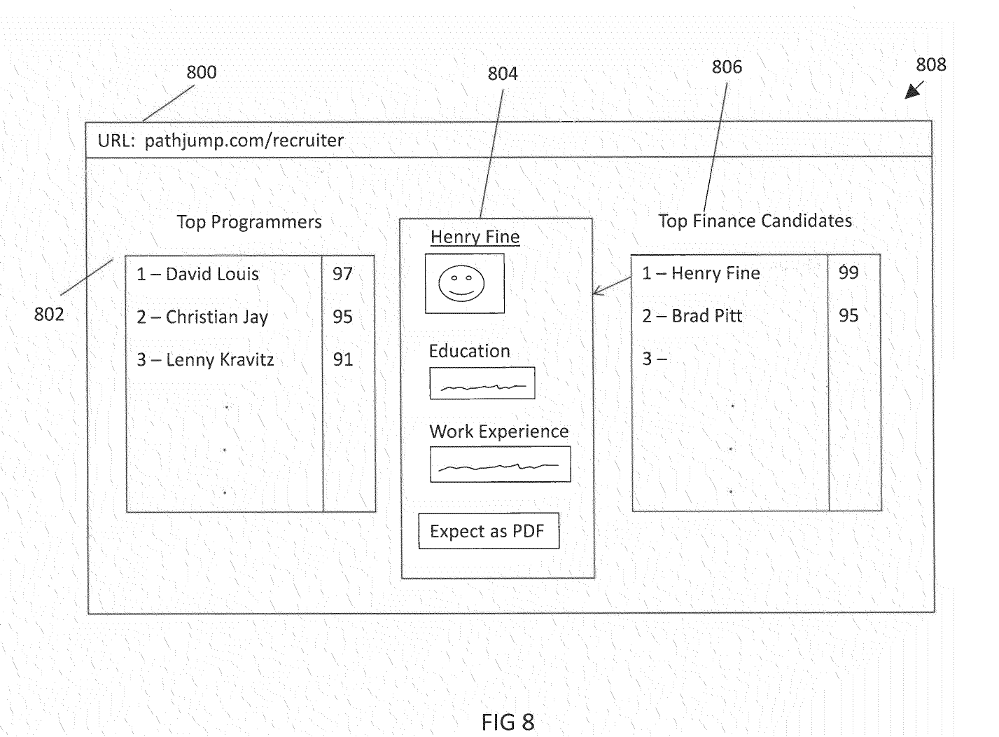

FIG. 8 illustrates an example recruiter interface 808 for earnings projection output, in accordance with certain embodiments. The illustrated user interface is an example, and numerous further implementations of this interface are within the scope of the present disclosure. FIG. 8 illustrates a browser used to input a URL 800 which connects the user to the present earnings projection system. In FIG. 8, candidates are ranked according to criteria within the ranking database and numbered 1-100. Multiple subsets of profiles may be compared. For example, one ranking can include programmers 802 and one ranking can include finance professionals 806. Individual profiles 804 can be examined using operations within recruiter user interface 808.

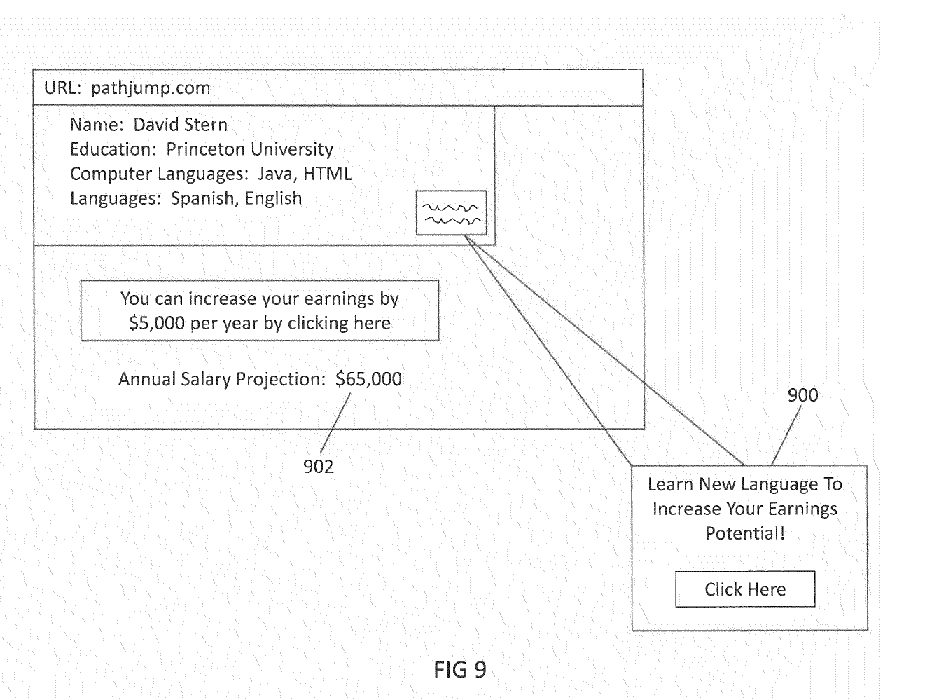

FIG. 9 illustrates an example advertisement within earnings projection system 106, in accordance with certain embodiments. In some embodiments, the user's earnings output 902 is provided with nearby targeted advertisements 900. Targeted advertisement 900 is based, directly or indirectly, on earnings projection output 902 and may use data within comparable profiles to provide areas where a user can increase his or her earnings.

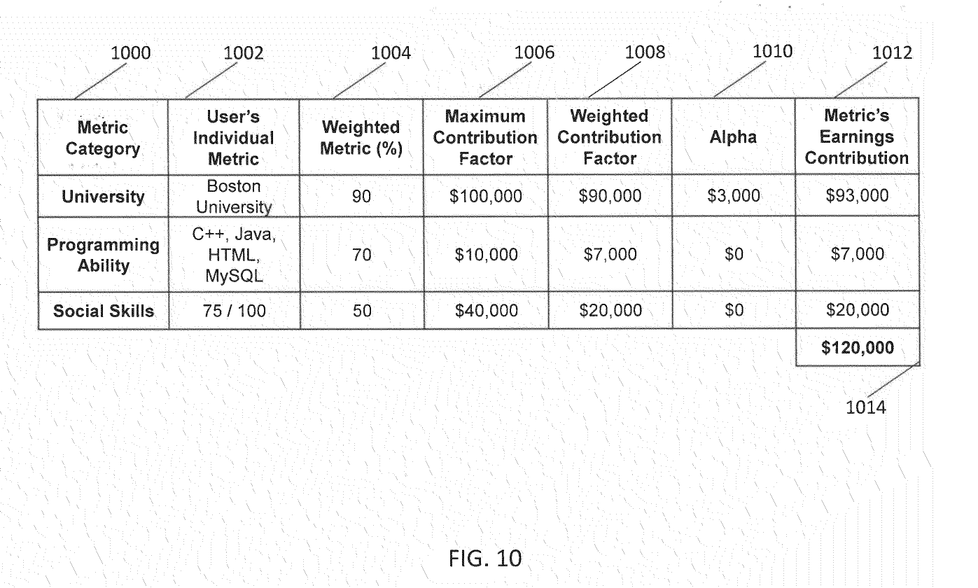

FIG. 10 illustrates an example earnings projection systems calculation, in accordance with certain embodiments. The metrics are grouped into categories 1000. In some embodiments, metric categories may be both quantitative and qualitative. For example, for “social skills,” a less traditionally quantified skill is listed as a metric category. The user's individual metric 1002 for each metric category is retrieved. The user's individual metric 1002 is then compared to the metric's ranking database to determine weighted metric 1004. As illustrated in FIG. 10, the maximum contribution factor 1006 for the metrics is multiplied by weighted metric 1004 to obtain weighted contribution factor 1008. As illustrated in FIG. 10, another coefficient alpha 1010 is added to the weighted contribution factor 1008 to determine the metric's earnings contribution 1012. The alpha coefficient functions to adjust the projections based on criteria outside of profile metrics. For instance demographic changes expected from a study by the department of labor may be integrated in order to adjust the contribution of the factor and represented in an alpha adjustment. Once the calculations are performed for each metric, summation 1014 of every metric's earnings contribution is calculated. FIG. 10 illustrates output of annual salary per year but the output may be varied to produce other output formats. Similarly, although a specific computation is illustrated here, this is not meant to be a comprehensive illustration of all the calculations which are covered under the present systems and methods.

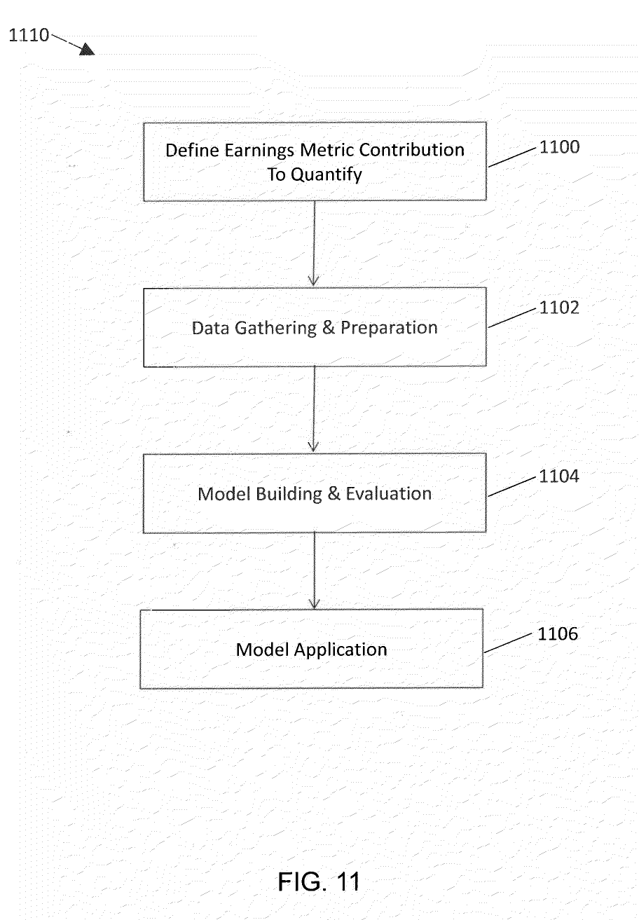

FIG. 11 illustrates an example flowchart of process 1110 in which Knowledge Discovery in Databases (KDD) is used within earnings projection system 106, in accordance with certain embodiments. In some embodiments, external and/or internal data may be used to obtain the weightings and coefficients used in the present earnings projection system. Data can also be processed in real time, to update dynamically the output from the present earnings projection system. The present system identifies a specific earnings contribution metric to be quantified (step 1100). For example, the variable might be the number of foreign languages in which a user has advanced proficiency. The present system gathers and prepares a dataset of actual user's career earnings either from internal and/or external databases (step 1102) to analyze how much the specific metric contributes to a user's earnings. In some embodiments, the dataset may be adjusted to isolate only the effect on earnings of the specific metric of interest. The present system constructs a model to project the earnings metric contribution of that specific metric, based on the analyzed dataset (step 1104). The model can also be tested continuously to improve the accuracy of the earnings metric contribution of the specific metric. The model can then be used on new user profiles to project various earnings metric contributions (step 1106). Although FIG. 11 illustrates a narrow illustration, numerous implementations of Knowledge Discovery in Databases (KDD) Process and “Big Data” can be used within the present earnings projection system to improve the system's efficacy.

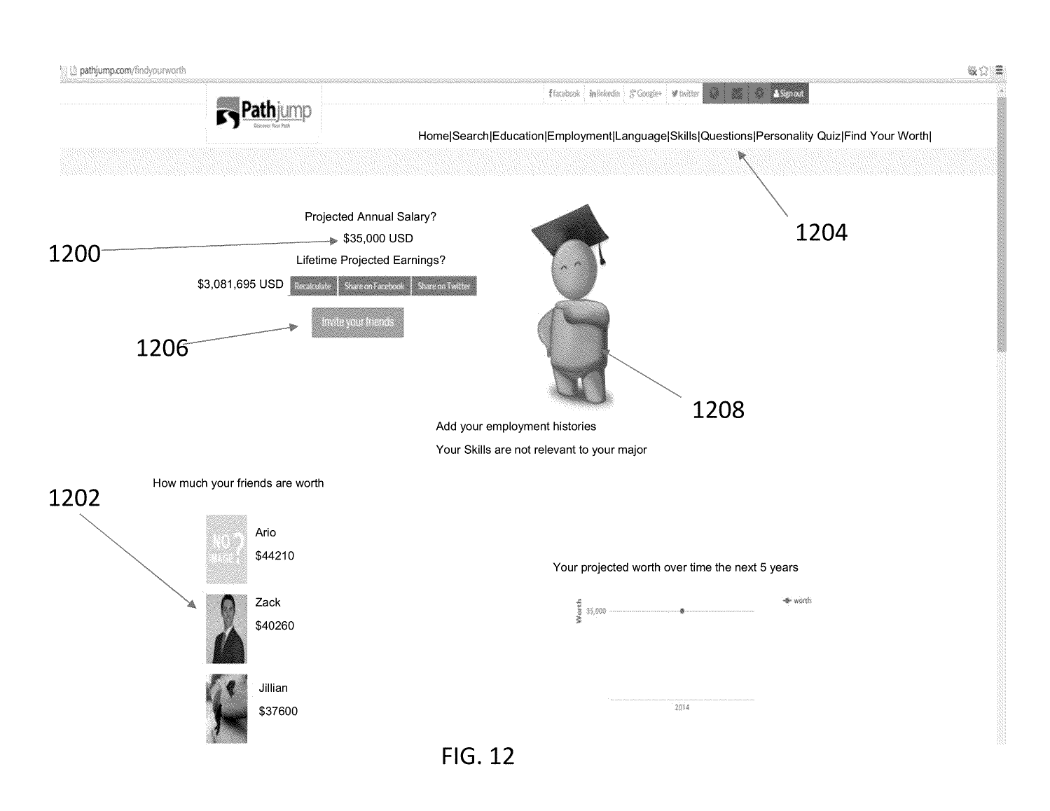

FIG. 12 illustrates a user interface for an earnings projection system within an online career network. The user's projected earnings 1200 are displayed within the online career network concurrently with a view of the user's earnings in relation to their other connections within the online career network 1202 and/or other networks linked with the online career network (Facebook, LinkedIn etc. . . . ). The presentation of users' earnings in relations to their connections allows the user to learn what makes a strong applicant in terms of earnings potential, and thus allows the user to further understand what they can do to increase their future earnings. The earnings projection system is integrated within the online career network, offering the user the ability to migrate to other sections of the online career network via links 1204. These other sections can be focused on numerous other areas related to careers, for instance job search or resume review. The earnings projection system also includes the ability to invite other users and/or connections 1206. A blue mascot is also utilized in the profile, but other gamification techniques could be incorporated to encourage user engagement.

Other embodiments are within the scope and spirit of the present systems and methods. For example, the functionality described above can be implemented using software, hardware, firmware, hardwiring, or combinations of any of these. One or more computer processors operating in accordance with instructions may implement the functions associated with projecting career earnings in accordance with the present disclosure as described above. If such is the case, it is within the scope of the present disclosure that such instructions may be stored on one or more non-transitory processor readable storage media (for example, a magnetic disk or other storage medium). Additionally, as described earlier, modules implementing functions may also be physically located at various positions, including being distributed such that portions of functions are implemented at different physical locations.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

We claim:

1. A computerized method of encouraging user engagement in an online career network by leveraging employment-related information corresponding to the users in the online career network, the method comprising:
receiving, by a computing device, profile information corresponding to a user and a request for an earnings projection corresponding to the user, the profile information comprising at least one category of information related to at least one of skills, employment or education;
extracting, by the computing device, a data profile subset based on the request, the data profile subset including a set of the at least one category from the user profile information;
assigning, by the computing device, a score to the user profile information, wherein assigning the score comprises at least one of:
comparing, by the computing device, the data profile subset with user profile data from a database of user profiles, the database user profiles including at least one category in common with the at least one category from the user profile information; and
calculating, by the computing device, the score by at least one weight to the at least one category; and
outputting, by the computing device, a user output based on the score, the user output comprising at least one of:
projected earnings corresponding to the user in relation to a set of profiles from the database of user profiles, and
a link to an earning tool, the earning tool comprising an activity related to increasing projected earnings of the user.

2. The computerized method of claim 1, wherein the user comprises a plurality of users and the data profile subset comprises a plurality of data profile subsets.

3. The computerized method of claim 2, wherein extracting, by the computing device, a plurality of data profile subsets based on the request further comprises extracting, based on the request, data profile subsets from a subset of the plurality of users.

4. The computerized method of claim 1, wherein the earnings projection output is configured in at least one alpha and numerical format to show an absolute ranking and a relative ranking of the user.

5. The computerized method of claim 2, wherein outputting a user output further comprises outputting information from a subset of the plurality of users based on a user filter request.

6. The computerized method of claim 5, wherein the user filter request comprises filtering the plurality of users based on at least one of employment, skills and education.

7. The computerized method of claim 1, further comprising outputting industry salary data corresponding to the user profile.

8. The computerized method of claim 1, wherein the user output is based on a user criteria selection, the user criteria selection comprising profile values, profile subsets, Boolean value, maximum amount of profiles, and range of profile attribute values.

9. The computerized method of claim 1, wherein the activity comprises performing a scenario analysis, the scenario analysis comprising:
receiving, by the computing device, a user altered set of profile information; and
changing the projected earnings based on the user altered set of profile information.

10. The computerized method of claim 1, wherein the activity comprises a game.

11. The computerized method of claim 1, wherein the activity comprises providing a factor that increases earning potential.

12. The computerized method of claim 11, wherein the earning tool further comprises a job opening corresponding to the factor.

13. The computerized method of claim 11, wherein the factor comprises at least one of location, technical skills, soft skills, recommendations, test scores, social skills, work experience and education.

14. The computerized method of claim 11, further comprising outputting an advertisement related to the factor.

15. The computerized method of claim 11, further comprising outputting a recommended career network connection related to the factor.

16. The computerized method of claim 11, further comprising outputting relevant online content related to the factor.

17. The computerized method of claim 1, further comprising a social feature, the social feature configured to send an invitation to a third party to contribute to the profile information.

18. The computerized method of claim 1, further comprising sending, by the computing device, the user output to an online network, the online network comprising a social network, a career network, and a professional network.

19. The computerized method of claim 1, further comprising adjusting the user output based on receiving a new category in addition to the set of the at least one category in the profile information.

20. The computerized method of claim 1, wherein the profile information comprises at least one of user entered data, data retrieved from an online career network, and data stored in a database.

21. The computerized method of claim 1, wherein the user output is made available for display on at least one of a website corresponding to the user in an online career network and a website corresponding to the user online social network site.

22. A system for encouraging user engagement in an online career network by leveraging employment-related information corresponding to the users in the online career network, the system comprising a memory containing instructions for execution by a processor, the processor configured to:
receive profile information corresponding to a user and a request for an earnings projection corresponding to the user, the profile information comprising at least one category of information related to at least one of skills, employment or education;
extract a data profile subset based on the request, the data profile subset including a set of the at least one category from the user profile information;
assign a score to the user profile information, wherein in assigning the score the processor is further configured to:
compare the data profile subset with user profile data from a database of user profiles, the database user profiles including at least one category in common with the at least one category from the user profile information; and
calculate the score by at least one weight to the at least one category; and
output a user output based on the score, the user output comprising at least one of:
projected earnings corresponding to the user in relation to a set of profiles from the database of user profiles, and
a link to an earning tool, the earning tool comprising an activity related to increasing projected earnings of the user.

23. A non-transitory computer readable medium having executable instructions operable to cause an apparatus to:
receive profile information corresponding to a user and a request for an earnings projection corresponding to the user, the profile information comprising at least one category of information related to at least one of skills, employment or education;
extract a data profile subset based on the request, the data profile subset including a set of the at least one category from the user profile information;
assign a score to the user profile information, wherein in assigning the score the processor is further configured to:
compare the data profile subset with user profile data from a database of user profiles, the database user profiles including at least one category in common with the at least one category from the user profile information; and
calculate the score by at least one weight to the at least one category; and
output a user output based on the score, the user output comprising at least one of:
projected earnings corresponding to the user in relation to a set of profiles from the database of user profiles, and
a link to an earning tool, the earning tool comprising an activity related to increasing projected earnings of the user.
